(19) United States
(12) Patent Application Publication
(10) Pub. No.: US 2010/0086697 A1
(43) Pub. Date: Apr. 8, 2010

(54) Method of protecting outdoor structures

(76) Inventor: Nicolas J. Pjatikin, Sewell, NJ (US)

Correspondence Address: Hollstein Keating Cattell Johnson & Goldstein;Willow Ridge Executive Office Park, Suite 301, 750 Route 73 South, Marlton, NJ, 08063, US

(21) Appl. No.: 12/286,878

(22) Filed: Oct. 2, 2008

(51) Int. Cl. B05D 3/02

(52) U.S. Cl. 427/385.5

(57) ABSTRACT

The method of the present invention employs a unique adhesive primer which is applied to the outer surface of an exterior structure. The primer is subject to specific, prolonged, and measured drying periods in order to form an adhesive agent on the outer surface of the structure. Following the premeasured drying time, a polyurethane/polyurea liquid mixture comprising various polyol, resin, UV stabilizer, and isocyanate components, with an optional capsicum derivative, is applied over the adhesive agent on the outer surface. This application process provides a permanent bond of the polyurethane/polyurea liquid mixture to the structure, through the adhesive agent and into the internal composite matter of the structure. The result is a solid protective coating bonded through the outer surface of the exterior structure which actually extends into the internal matter of the structure. The permanency of this coating will not only provide the requisite protection against natural environmental elements and destruction by marine and other organisms, but, since it is permanently bonded to the interior of the structure itself, will never wear, come loose, peel off, or in any manner detach from the structure. It also ensures that any pressure treated chemicals in the exterior structure are sealed within the coating. The structure thus has a permanent hard protective coating which will last as long as the structure itself lasts and, in fact, will actually prolong the useful life of the structure.

### BACKGROUND OF THE INVENTION

Environmental elements of nature, including wind, sun, rain, freezing conditions, acid-rain and other pollutants, reek havoc on exterior structures found in outdoor, unprotected locations. In the marine environment, salt in the air and seawater provide added threats to the deterioration of such structures. Moreover, destructive organisms, especially prevalent in areas adjacent to bodies of water, literally gnaw through wood material, destroying the integrity of poles, pilings, piers, seawalls and other structural members. Especially destructive are marine borers, waterborne, termite type insects which literally eat wood to survive.

There have been prior attempts to address the destructive, deterioration of both land and marine structures. For instance, the encapsulation of pilings and similar structures with polyurethane products has found some degree of success. However, the materials used and their associated methods of application result in less than adequate protection or only temporary fixes. Such coverings can not withstand the harsh forces of nature and will routinely wear to the point of failure. These coverings will eventually break off, again leaving the structures vulnerable to environmental elements and organism destruction. It is thus evident that prior protective coverings and their methods of application have not addressed the problem of the continuing effectiveness, over time, of outdoor structures—to maintain the structure throughout its useful life and, in so doing, actually prolong this useful life.

### SUMMARY OF THE INVENTION

It is thus the object of the present invention to overcome the limitations and disadvantages of prior outdoor protective coatings and their methods and results of application. The method of the present invention employs a unique adhesive primer which is applied to the outer surface of an exterior structure. The primer is subject to specific, prolonged, and measured drying periods in order to form an adhesive agent on the outer surface of the structure. Following the premeasured drying time, a polyurethane/polyurea liquid mixture comprising various polyol, resin, UV stabilizer, and isocyanate components, with an optional capsicum derivative, is applied over the adhesive agent on the outer surface. This application process provides a permanent bond of the polyurethane/polyurea liquid mixture to the structure, through the adhesive agent and into the internal composite matter of the structure. The result is a solid protective coating bonded through the outer surface of the exterior structure which actually extends into the internal matter of the structure. The permanency of this coating will not only provide the requisite protection against natural environmental elements and destruction by marine and other organisms, but, since it is permanently bonded to the interior of the structure itself, will never wear, come loose, peel off, or in any manner detach from the structure. The structure thus has a permanent hard yet flexible protective coating which will last as long as the structure itself lasts and, in fact, will actually prolong the useful life of the structure.

The components and method of their application of the present invention is particularly directed to wood and wood type material, to encapsulate and seal structures composed of such material. However, the components and method of application can also be used on metal to prevent rust and corrosion and on concrete structures.

It is contemplated that this invention finds meaningful application on utility poles, construction beams and joist members, cross-bracing, ground penetrating marine or foundation support pilings, docks and dock supports, seawalls, dock foundations, bumpers, bulkhead and bulkhead planking, decking, piers, floating docks, and virtually any structural element, either landbased or marine, where environmental elements and destructive organisms take a harsh toll.

The components of the present invention are also environmentally friendly, presenting no hazard to the environment. Neither the application of the components nor the final product have any adverse impact, whatsoever, on the environment.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a representation of the liquid adhesive primer application process of the present invention.

FIG. 2 is a representation of the preparation of the liquid hybrid elastomer component of the present invention.

FIG. 3 is a representation of the application of the liquid hybrid elastomer component of the present invention.

FIG. 4 is a depiction of the adhesive bond resulting from the present invention.

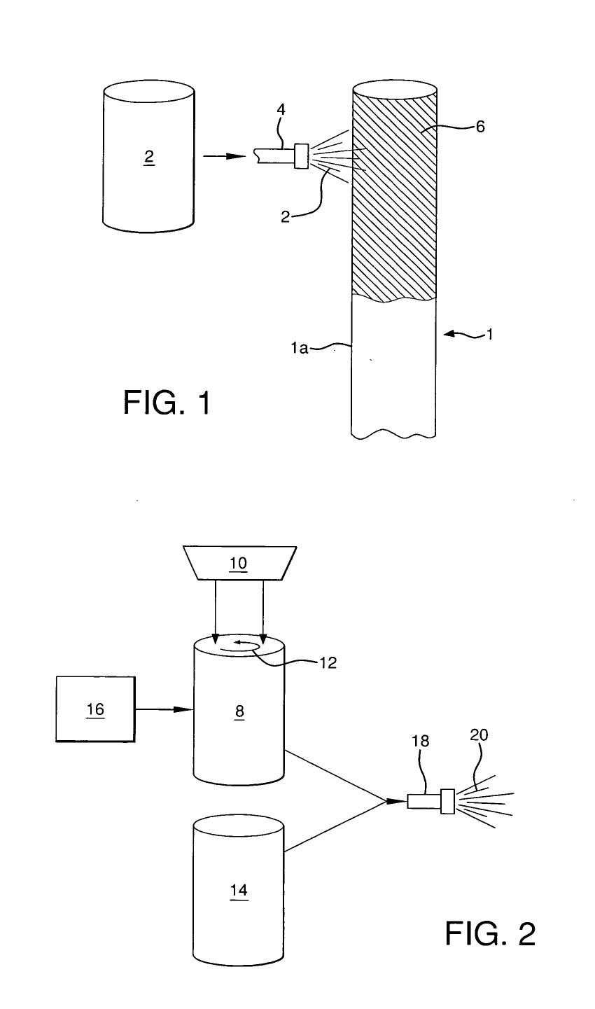

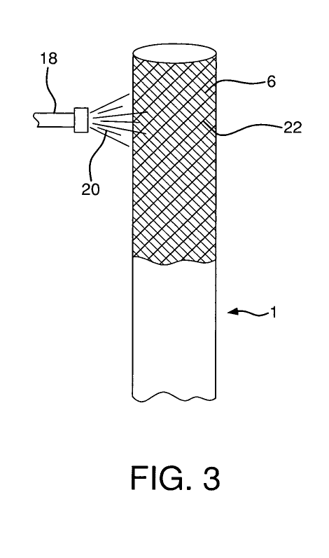

### DETAILED DESCRIPTION OF THE INVENTION

Marine piling, utility pole, or like exterior structure 1 is located outdoors, exposed to the environment and the natural, harsh, adverse elements associated with that environment. Such elements include rain, sun, wind, freeze, airborne pollutants, bio-organisms and, especially in marine settings, salt, seawater and marine growth. Key to the method of protecting such exterior structures involves the use of a primer adhesive coating and a specially treated and blended polyurethane/polyurea hybrid elastomer compound.

The unique method of the invention directed toward the protection of external structures, contemplates the use of a solvent-based, polyurethane adhesive primer. An example of such a product is currently marketed as PILE ARMOR PRIMER™. This primer is very effective over both pressure treated and non-pressure treated wood to react with the substrate to promote superior adhesion of coatings. This is especially true when the moisture content of the wood is above approximately 19%. Among other things, the primer serves to improve the cohesive strength of surfaces for maximum adhesion, provides for an excellent bond between the substrate and applied coating, removes substrate air pockets to prevent bubbles and pinholes, and allows for rapid drying to reduce the potential for dirt intrusion and meteorological interruptions. Rheology is another characteristic of this primer, allowing for optimum coverage and penetration.

Adhesive primer 2 is initially applied by spray nozzle 4 or, alternatively brush or roller, to outer surface 1a of exterior structure 1. Exterior surface 1 is depicted as having internal composite matter 1b. Before application of adhesive primer 2, outer surface 1a must be dry and free of dirt, loose debris, oils, grease or other substances that will interfere with the bonding process of the invention. The primer application process may not be required if the moisture content of composite matter 1b is below approximately 19%.

After application, adhesive primer 2 must be allowed to dry to its adhesive form 6 on outer surface 1a of structure 1 for a period of approximately thirty minutes to two hours to ensure that it has optimal effect as a bonding or adhesive agent between the structure and the polyurethane/polyurea hybrid elastomer compound to be applied in the next step in the method. As primer adhesive 6 dries, it infiltrates from outer surface 1a of exterior structure 1 into the internal composite matter 1b of the structure.

Liquid mixture 8 forms one component of the polyurethane/polyurea hybrid elastomer compound 20 of the invention. Mixture 8 comprises polyether polyols, polyureas, and resins mixed with a UV stabilizer and optional color pigment. For marine applications, cayenne pepper 16 or equivalent capsicum derivative to repel and inhibit the growth of organisms is added to mixture 8. Mixture 8 is mixed 12 by, for instance, a spiral mixing blade powered by air driven motor 10. This mixing process must continue for at least thirty minutes to ensure there is a homogeneous mix of the polyol resin, UV stabilizer, and optional cayenne pepper and pigment. The mixing of the mixture 8 must be continuous throughout the application of the polyurethane/polyurea hybrid elastomer compound 20, described hereinafter, especially to keep the cayenne pepper suspended for even distribution throughout the elastomer compound.

The next critical component of polyurethane/polyurea hybrid elastomer compound 20 of the invention is isocyanate 14, a key element in the formulation of polyurethanes. Specifically, a modified diphenylmethane diisocyanate prepolymec is contemplated. Isocyanate 14 is pumped to spray applicator 18, where it is mixed, at the tip of the applicator, with mixture 8, simultaneously being pumped to the applicator. The resulting compound product emitted from applicator 18, in liquid form, is the polyurethane/polyurea hybrid elastomer compound 20 which is free from pin holes, since no volatile organic compounds are present. An example of such an elastomer compound product currently being commercially produced is PILE ARMOR™. This product is a monolithic containment barrier which has excellent toughness to provide a protective, non-leeching coating on the outer surfaces of exterior structures. It protects such structures not only from damage caused by adverse environmental elements, but also from damage caused by human error, such as by the scrapping of pilings by vessels, in the case of marine use.

Once primer adhesive 6 has sufficiently dried on and into external structure 1, applicator 18 is used to spray the liquid polyurethane/polyurea hybrid elastomer compound 20, as the protective coating, onto outer surface 1a of the structure. Elastomer compound 20 can also be applied by brush or roller. It is applied at a thickness of approximately 1/16″ to ⅛″, with a minimum of ⅛″ at top and bottom of external structure 1, to ensure extra protection during installation. Elastomer compound 20 will dry within thirty seconds after application and fully cure in twenty-four hours. It can be applied in ambient temperatures between 35° Fahrenheit to 200° Fahrenheit. After drying, solid polyurethane/polyurea outer coating 22 is formed.

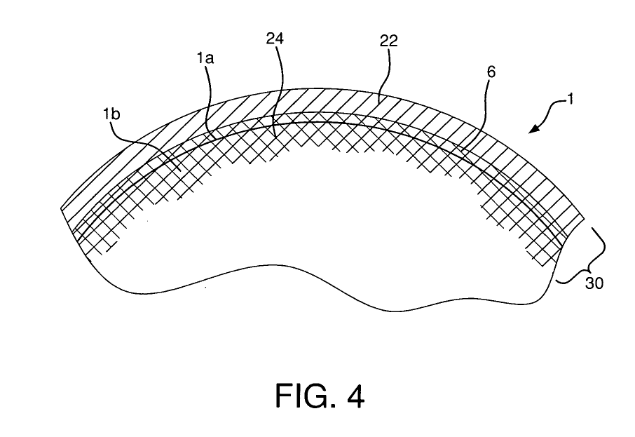

This process results in protective coating 22 being permanently bonded to exterior structure 1. The permanent connection is made possible by adhesive primer 6 which causes the liquid elastomer compound 20 initially applied to infiltrate into and bind with the internal composite matter 1b of external structure 1, e.g. at 24 in FIG. 4, to ultimately dry into integral bond 30 between coating 22 and the composite matter, and hence the external structure.

The resulting coating 22 comprises a solid, hard yet flexible shell which is formed as an integral part of structure 1 itself. It results in a smooth surface, negating the splintering effect of rough wood. Coating 22 will not wear, fail, or detach, but will instead last for the life of the structure, actually prolonging the useful life of the structure. The coating will also provide decorative, color options, which have been unavailable in the past. Most importantly, coating 22 will provide a highly effective encapsulating protective layer, shielding the structure from the effects of the environment, including the harmful destruction of borers and other organisms. It will also prevent the chemicals in pressure treated wood from leaching out.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. The method of protecting and preserving outdoor, exterior-based structures from adverse environmental elements comprising the steps of:
providing an adhesive primer;
providing an exterior structure having an outer surface and internal composite matter;
applying the adhesive primer to the outer surface of the exterior structure;
allowing the adhesive primer to dry on the outer surface of the external structure for a prolonged, measured period of time;
forming an adhesive agent on the outer surface of the external structure by the action of the adhesive primer on the outer surface;
providing a polyurethane/polyurea liquid mixture;
applying the polyurethane/polyurea mixture to the adhesive agent on the outer surface of the external structure;
permanently bonding the polyurethane/polyurea liquid to the exterior structure, through said adhesive agent and the outer surface, into the internal composite matter; and
forming a solid protective coating bonded through the outer surface of the exterior structure which extends into the internal matter of the exterior structure.

2. The method as in claim 1 further comprising the step of adding a marine organism growth inhibitor to the polyurethane/polyurea liquid prior to applying the polyurethane/polyurea liquid onto the adhesive agent on the outer surface of the exterior structure.

3. The method as in claim 2 wherein the growth inhibitor is a capsicum derivative.

4. The method as in claim 1 comprising the further step of adding a UV stabilizer to the polyurethane/polyurea liquid prior to applying the polyurethane/polyurea liquid onto the adhesive agent on the outer surface of the external structure.

5. The method as in claim 1 wherein the polyurethane/polyurea liquid is a hybrid elastomer formed from resin and isocyanate.

6. The method as in claim 1 wherein the prolonged, measured period of time is approximately thirty minutes to two hours.

7. The method as in claim 1 wherein the composite matter has a moisture content above approximately 19%.

8. The method as in claim 1 wherein the external structure is a marine piling or other structure exposed to the marine environment.

9. The method as in claim 1 wherein the external structure is a ground penetrating support piling.

10. The method as in claim 1 wherein the external structure is a utility pole.

11. The method as in claim 1 wherein the application of the adhesive primer and polyurethane/polyurea liquid is by spray gun, brush, or roller.
